(19) United States
(12) Patent Application Publication
(10) Pub. No.: US 2007/0083892 A1
(43) Pub. Date: Apr. 12, 2007

(54) Display apparatus and channel navigation method thereof

(75) Inventors: Young-hwa Yun, Seoul (KR); Sung-youn Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/543,945

(22) Filed: Oct. 6, 2006

(30) Foreign Application Priority Data
Oct. 8, 2005 (KR) 10-2005-0094667

(51) Int. Cl. H04N 5/445

(52) U.S. Cl. 725/39

(57) ABSTRACT

A display apparatus and a channel navigation method thereof are provided. The channel navigation method of a display apparatus using picture-in-picture (PIP), included: processing video signals of a currently tuned channel to be displayed in a main picture; generating a channel list including a sub picture based on the video signal corresponding to a predetermined channel when a channel navigation function is selected; and displaying the generated channel list on an area of the main picture. With this method, a channel list including a PIP picture is displayed on an area of a main picture, so that a user can select a desired channel through broadcasting information and pictures about other channels while viewing the main picture.

### CROSS-REFERENCE TO RELATED PATENT APPLICATION

This application claims priority from Korean Patent Application No. 2005-0094667, filed on Oct. 8, 2005, in the Korean Intellectual Property Office, the disclosure of which is incorporated herein by reference.

### BACKGROUND OF THE INVENTION

1. Field of the Invention

The present invention relates to a display apparatus and a channel navigation method thereof, more particularly, to a display apparatus and a channel navigation method thereof, which can allow a user to navigate channels through a displayed channel list.

2. Description of the Related Art

Generally, in a television (TV) set which receives broadcasting signals and displays a picture based on the broadcasting signals, a channel up/down key or a channel number selection key is used for shifting channels.

Recently, digital broadcasting has transmitted electronic program guide (EPG) information, i.e., broadcasting program information provided for convenience in selecting the channels. A digital TV receives the EPG information and displays it in a type of table on the screen.

Through the EPG information, a user can obtain the broadcasting program information about a currently displayed channel or channels to be displayed and select a desired channel. However, the EPG information is generally displayed as a full screen, so that a user cannot see a picture corresponding to the channel while selecting the channel through the EPG information. Further, the EPG information is displayed as a timetable mostly represented by text, so that a user cannot see a picture corresponding to the channel while navigating the channels.

### SUMMARY OF THE INVENTION

The present invention provides a display apparatus and a channel navigation method thereof, in which a channel list including a picture-in-picture (PIP) picture is displayed in a predetermined region of a main picture, so that a user can select his/her wishing channel through broadcasting information and a picture of other channels while viewing the main picture.

According to an aspect of the present invention, there is provided a channel navigation method of a display apparatus using PIP, comprising: processing a video signal of a currently tuned channel to be displayed in a main picture; generating a channel list including a sub picture based on the video signal corresponding to a predetermined channel when a channel navigation function is selected; and displaying the generated channel list on an area of the main picture.

According to an aspect of the invention, the generating the channel list comprises displaying the sub picture based on a video signal corresponding to the channel selected through the channel list.

According to an aspect of the invention, the channel list includes broadcasting information related to at least one of a channel name, a program name and a televising time.

According to an aspect of the invention, the channel navigation method further comprises: moving the broadcasting information displayed on the channel list in up/down directions corresponding to up/down selection of the channel when an up/down navigation function for the channel displayed on the channel list is selected, and displaying the sub picture based on the video signal corresponding to the channel selected by the up/down selection.

According to an aspect of the invention, the channel navigation method further comprises: moving a highlight in up/down directions corresponding to up/down selection of the channel when an up/down navigation function for the channel displayed on the channel list is selected, and displaying the sub picture based on the video signal corresponding the highlighted channel.

According to an aspect of the invention, the channel navigation method further comprises processing the video signal of the channel displayed on the sub picture to be displayed as the main picture when the channel displayed on the sub picture is selected.

According to an aspect of the invention, the channel list is displayed on either of a right side or a left side in the main picture.

According to an aspect of the invention, the sub picture is displayed in the middle of the channel list.

According to an aspect of the invention, the channel navigation method further comprises receiving and storing EPG information, wherein the generating of the channel list comprises generating the channel list by extracting the broadcasting information corresponding to a current time from the EPG information.

According to another aspect of the present invention, there is provided a display apparatus comprising: a broadcasting receiver for receiving broadcasting signals; a signal processor for processing the broadcasting signals received from the broadcasting receiver to be displayed as a main picture and a sub picture; and a display unit for displaying a picture based on the processed broadcasting signals, the display apparatus comprising: a user selection unit; a channel list generator for generating a channel list including broadcasting information; and a controller for controlling the channel list including the sub picture corresponding to the broadcasting signal of a predetermined channel to be displayed on an area of the main picture when a channel navigation function is selected through the user selection unit.

According to an aspect of the invention, the display apparatus further comprises an EPG storing unit that stores EPG information received from the broadcasting receiver, wherein the controller extracts the broadcasting information corresponding to a current time from the EPG storing unit, and controls the channel list generator to generate the channel list.

According to an aspect of the invention, the broadcasting information displayed on the channel list comprises information related to at least one of a channel name, a program name and a televising time.

According to an aspect of the invention, the controller controls the signal processor to display the sub picture based on the broadcasting signal corresponding to the channel selected through the channel list.

According to an aspect of the invention, the controller controls the signal processor to move the broadcasting information displayed on the channel list according to up/down selection of the channel in up/down directions when an up/down navigation function for the channel displayed on the channel list is selected through the user selection unit, and to display the sub picture based on the video signal of the channel corresponding to the up/down selection.

According to an aspect of the invention, the controller controls the signal processor to move a highlight in up/down directions according to up/down selection of the channel when an up/down navigation function for the channel displayed on the channel list is selected through the user selection unit, and to display the sub picture based on the video signal of the highlighted channel.

According to an aspect of the invention, the controller controls the signal processor to process the video signal of the channel displayed on the sub picture to be displayed as the main picture when the channel displayed on the sub picture is selected.

According to an aspect of the invention, the channel list is displayed on either of a right side or a left side in the main picture, and the sub picture is displayed in the middle of the channel list.

According to an aspect of the invention, the controller controls the information related to the televising time, the channel name and the program name to be displayed translucently on the channel list.

### BRIEF DESCRIPTION OF THE DRAWINGS

The above and/or other aspects of the prevent invention will become apparent and more readily appreciated from the following description of the exemplary embodiments, taken in conjunction with the accompany drawings, in which:

FIG. 1 is a control block diagram illustrating a display apparatus according to an exemplary embodiment of the present invention;

FIG. 2 is a control flow chart illustrating a channel navigation method of the display apparatus according to an exemplary embodiment of the present invention; and

FIG. 3 is a display picture illustrating a channel list according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

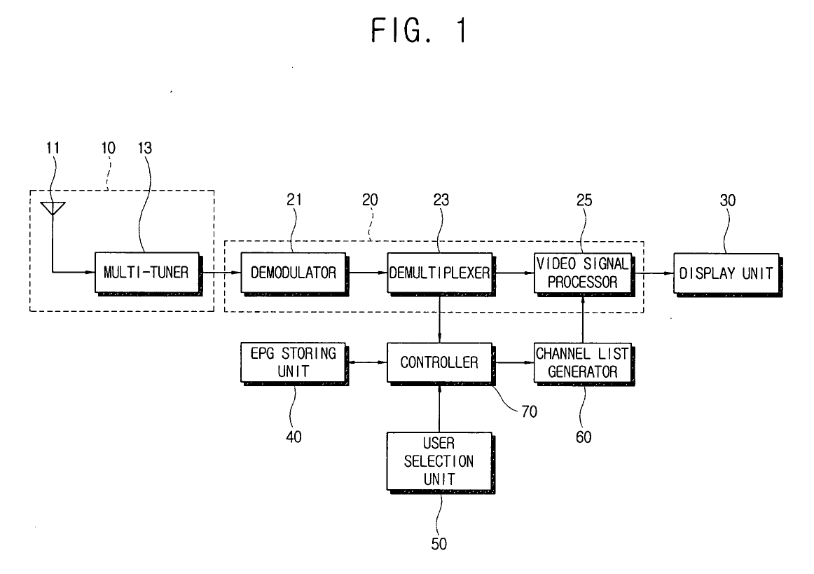

FIG. 1 is a control block diagram illustrating a display apparatus according to an exemplary embodiment of the present invention. A display apparatus according to an exemplary embodiment of the invention has a PIP function. Therefore, the display apparatus set can be tuned to a plurality of channels at the same time, and process broadcasting signals corresponding to the channels to be displayed as a main picture and a sub picture.

In the exemplary embodiment, the display apparatus is embodied as a digital TV which receives and processes digital broadcasting signals.

As shown in FIG. 1, the display apparatus comprises a broadcasting receiver 10, a signal processor 20, a display unit 30, an EPG storing unit 40, a user selection unit 50, a channel list generator 60, and a controller 70.

The broadcasting receiver 10 includes an antenna 11 and a multi-tuner 13, and the signal processor 20 includes a de-modulator 21, a demultiplexer 23, and a video signal processor 25.

The multi-tuner 13 comprises a single tuner or a plurality of tuners to select broadcasting signals received from the antenna 11. Thus, the multi-tuner 13 is tuned subsequently or concurrently to the broadcasting signals having frequency bands corresponding to control signals of the controller 70 (to be described below).

The tuned digital broadcasting signals of the channels undergo a vestigial sideband (VSB) demodulation process and an error correction process by the demodulator 21 and are output in a type of transport stream. Then, the digital broadcasting signals are separated into video signals, audio signals, and various appendix data defined in Program and Service Information Protocol (PSIP) by the demultiplexer 23 and output in a type of bit stream.

Further, the video signals separated through the demultiplexer 23 are processed by the video signal processor 25 and output to the display unit 30.

The video signal processor 25 comprises a video decoder (not shown) which decodes the video signal separated by the demultiplexer 23, and a scaler which translates the decoded video signals to have the screen ratio, the resolution, the vertical frequency, etc. adapted to the output standard of the display unit 30. Further, the display unit 30 is applicable to various display modules such as a Digital Light Processing (DLP) projector, a Liquid Crystal Display (LCD), and a Plasma Display Panel (PDP), etc.

The audio signal decoded by an audio decoder (not shown) is output to a speaker (not shown).

As described above, the display apparatus according to an exemplary embodiment of the present invention can perform PIP processing, so the signal processor 20 may comprise a main picture processor (not shown) that processes the broadcasting signal corresponding to the main picture, and a sub picture processor (not shown) that processes the broadcasting signal corresponding to the sub picture. Each of the main/sub picture processors can have a decoder and a scaler.

Meantime, various appendix data based on PSIP separated by the demultiplexer 23 comprises EPG information that is guide information about a broadcasting program, and the received EPG information is stored in the EPG storing unit 40 under controls of the controller 70 (to be described below). The EPG information includes STT (System Time Table), MGT (Master Guide Table), VCT (Virtual Channel Table), RRT (Rating Region Table), EIT (Event Information Table) and ETT (Extended Text Table) information based on the PSIP.

The user selection unit 50 for selection of channel and channel navigation comprises a menu key provided on a remote controller, and a key signal generator for generating key signals in response to key manipulation. The user selection unit 50 can be implemented by a mouse, a keyboard, etc. or can be provided in a main panel of the display apparatus.

Based on the EPG information extracted by the controller 70, the channel list generator 60 generates a channel list including brief broadcasting information. The channel list includes the sub picture, namely, the PIP picture where the video signal processed by the sub picture processor is displayed as a picture. Here, the channel list generator 60 can be accomplished by an on screen display (OSD) generator.

The broadcasting information displayed by the channel list generator 60 may comprise brief information such as a channel name, a program name, a broadcasting time and so on. The channel list can be sorted according to the channels, thereby allowing a user to obtain the broadcasting information easily. Alternatively, the display method can be designed variously. The channel list generator will be described in more detail later.

The controller 70 controls corresponding function to be performed in response to the received key signals of the user selection unit 50, which can be accomplished by a controller or/and a processor of a central processing unit (CPU) and a microcomputer, etc.

In detail, in the case that a channel navigation function is selected through the user selection unit 50, the controller 70 controls the channel list generator 60 to generate the channel list according to extracted broadcasting information by extracting the broadcasting information responding to a current time from the EPG storing unit 40. At this point, the channels included in the channel list may include all channels through which effective broadcasting signals are received, but the channels being displayed in the screen may be a part of the channel list according to screen sizes.

Further, the controller 70 supplies a tuning control signal corresponding to the multi-tuner 13 such that the channel is displayed in the sub picture while performing the channel navigation function. Also, the controller 70 controls the processed broadcasting signals to be displayed as the sub picture, i.e., the PIP picture in an area of the generated channel list. At this point, the channel list including the sub picture is combined with the main picture currently being displayed, and is displayed on the display unit 30. The channel list can be displayed in an area of the main picture. Also, by displaying translucently the text corresponding to the broadcasting information displayed in the channel list, a user can see the main picture without inconvenience.

Further, the controller 70 controls the multi-tuner 13 and the signal processor 20 according to manipulation of the channel navigation key through the user selection unit 50, so that the broadcasting signals corresponding to the channel selected or indicated through a key on the channel list may be displayed in the sub picture. At this time, the position of the sub picture is unchanged, and the channel information displayed in the channel list can move corresponding to the manipulation of the key. Alternatively, a highlight may be moved. Also, the text for representing the broadcasting information of the channel displayed in the sub picture can be emphasized or enlarged as compared with those for other channels. Further, the broadcasting information of the channel displayed in the sub picture may be more detailed than other channels.

In the case that the channel displayed in the sub picture is chosen through the user selection unit 50, the controller 70 controls the signal processor 20 to process the broadcasting signals corresponding to the sub picture to be displayed as the main picture. Therefore, a user can choose a desired channel while the user watches real-time moving pictures and the broadcasting information of the channel included in the channel list by manipulating the channel navigation key.

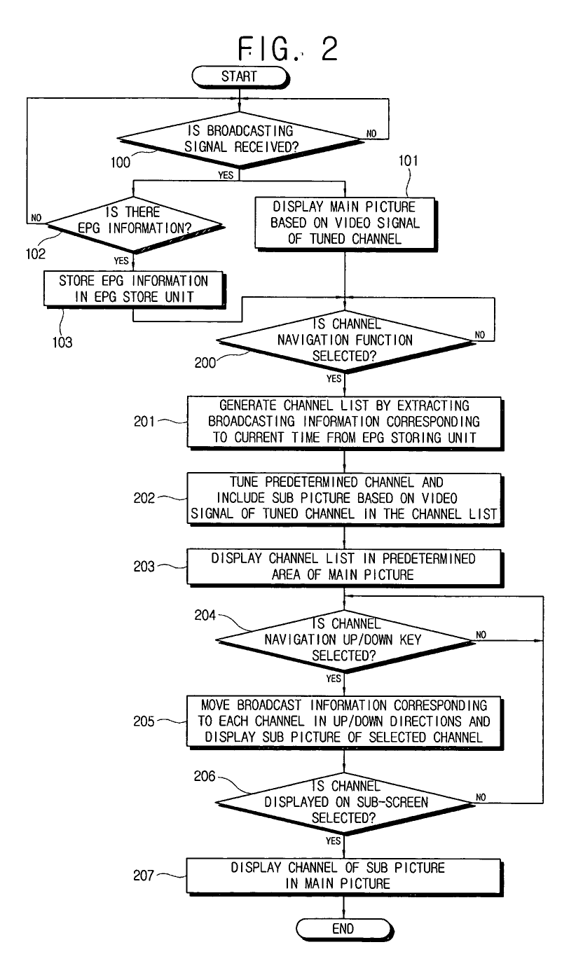

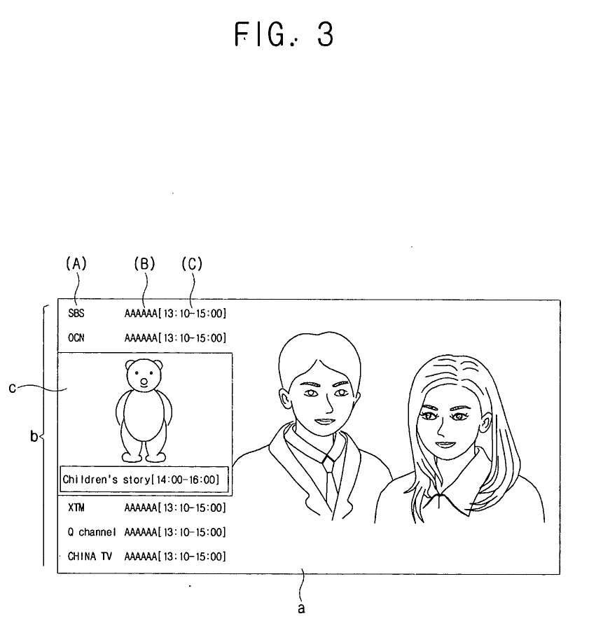

Referring to FIGS. 2 and 3, the channel navigation method of the display apparatus according to an exemplary embodiment of the invention will be explained.

FIGS. 2 and 3 show a display picture of the channel list and the channel navigation method of the display apparatus according to the exemplary embodiment of the present invention.

The controller 70 supplies the tuning control signal to the multi-tuner 13 and controls the multi-tuner 13 to receive the broadcasting signal corresponding to the channel selected through the user selection unit 50. When receives the broadcasting signals at operation 100, the controller 70 controls the signal processor 20 to display the video signal of the tuned channel on the main picture at operation 101. When the EPG information exists at operation 102, the EPG information separated by the demultiplexer 23 is stored in the EPG storing unit 40 at operation 103.

In the case that the channel navigation function is selected through the user selection unit 50 at operation 200, the controller 70 extracts the broadcasting information corresponding to a current time from the EPG storing unit 40 and controls the channel list generator 60 to generate the channel list based on the extracted broadcasting information at operation 201.

Further, by tuning the channel displayed in the sub picture on the basis of the navigation information, the controller 70 processes the tuned video signal as the sub picture to be included in the channel list at operation 202.

The video signal corresponding to the generated channel list and the video signal of the main picture are mixed through the signal processor 20 and displayed in the display unit 30, as shown in FIG. 3. Referring to FIG. 3, the channel list b including the sub picture c can be displayed on a left area of the main picture at operation 203.

Further, the channel list b includes the text information about a channel name A, a program name B, and a televising time C of each channel, in which the text information is displayed translucently. At this point, according to manipulation of the channel navigation key of the user selection unit 50, the text information of the highlighted or selected channel can be displayed as being emphasized and enlarged. As necessary, more detailed broadcasting information may be displayed for the highlighted or selected channel.

Further, the sub picture is positioned in the middle of the channel list, as shown in FIG. 3, the broadcasting information about the channel indicated or selected by the channel navigation key of the user selection unit 50, i.e., the text information corresponding to the sub picture is positioned under the sub picture.

In the case that the channel navigation up/down key of the user selection unit 50 is selected at operation 204, the controller 70 moves the broadcasting information of the channel displayed on the channel list in up/down directions, and displays the text information of the indicated or selected channels to be positioned under the sub picture at operation 205. Further, the controller 70 controls the signal processor 20 to tune and process the video signal of the selected or indicated channel to be displayed in the sub picture included in the channel list at operation 205.

Therefore, a user can obtain the information related to other channels while viewing the current channel displayed on the main picture since the user can watch the broadcasting information and real-time pictures corresponding to the desired channels by manipulating the channel navigation key.

Further, in the case that a user selects the channel displayed on the sub picture through the user selection unit 50 at operation 206, the controller 70 controls the signal processor 20 to process the channel displayed as the sub picture to be displayed as the main picture at operation 207. At the same time, the channel list disappears.

Therefore, a user can navigate desired channel information through the channel list displayed by the PIP channel navigation function, and choose a desired channel easily.

Although the display apparatus is embodied as a digital TV in the exemplary embodiment of the present invention, the present invention can be applied to an analog TV.

As described above, the present invention provides a display apparatus and a channel navigation method thereof, in which a channel list including a PIP picture is displayed on an area of a main picture, so that a user can select a desired channel through broadcasting information and pictures about other channels while viewing the main picture.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A channel navigation method of a display apparatus using picture-in-picture (PIP), comprising:
processing a video signal of a currently tuned channel to be displayed in a main picture;
generating a channel list including channel information and a sub picture corresponding to a channel if a channel navigation function is selected; and
displaying the generated channel list on an area of the main picture.

2. The channel navigation method according to claim 1, wherein the displaying the generated channel list comprises displaying a video signal corresponding to the channel selected through the channel list in the sub picture.

3. The channel navigation method according to claim 2, wherein the channel information comprises at least one of a channel name, a program name and a televising time.

4. The channel navigation method according to claim 3, further comprising:
moving the channel information displayed on the channel list in an up or down direction if a channel displayed on the channel list is selected using an up or down navigation function, and
displaying the video signal corresponding to the channel selected by the up or down navigation function in the sub picture.

5. The channel navigation method according to claim 3, further comprising:
moving a highlight of a channel displayed in the channel list in an up or down direction if the channel is selected using an up or down navigation function, and
displaying the video signal corresponding the highlighted channel in the sub picture.

6. The channel navigation method according to claim 5, further comprising processing the video signal of the channel displayed in the sub picture to be displayed as the main picture if the channel corresponding to the video signal displayed in the sub picture is selected.

7. The channel navigation method according to claim 6, wherein the channel list is displayed on one of a right side or a left side in the main picture.

8. The channel navigation method according to claim 7, wherein the sub picture is displayed in the middle of the channel list.

9. The channel navigation method according to claim 8, further comprising receiving and storing electronic program guide (EPG) information,
wherein the generating of the channel list comprises generating the channel list by extracting the channel information corresponding to a current time from the EPG information.

10. The channel navigation method according to claim 4, further comprising processing the video signal of the channel displayed in the sub picture to be displayed as the main picture if the channel corresponding to the video signal displayed in the sub picture is selected.

11. The channel navigation method according to claim 10, wherein the channel list is displayed on one of a right side or a left side in the main picture.

12. The channel navigation method according to claim 11, wherein the sub picture is displayed in the middle of the channel list.

13. The channel navigation method according to claim 12, further comprising receiving and storing electronic program guide (EPG) information,
wherein the generating of the channel list comprises generating the channel list by extracting the channel information corresponding to a current time from the EPG information.

14. A display apparatus comprising:
a broadcasting receiver which receives broadcasting signals;
a signal processor for processing the broadcasting signals received from the broadcasting receiver to be displayed as a main picture and a sub picture;
a display unit for displaying a picture based on the processed broadcasting signals;
a user selection unit;
a channel list generator which generates a channel list including channel information and the sub picture corresponding to a channel; and
a controller which controls the channel list generator to display the channel list on an area of the main picture if a channel navigation function is selected through the user selection unit.

15. The display apparatus according to claim 14, further comprising an electronic program guide (EPG) storing unit that stores EPG information received from the broadcasting receiver,
wherein the controller extracts the channel information corresponding to a current time from the EPG storing unit, and controls the channel list generator to generate the channel list.

16. The display apparatus according to claim 15, wherein the channel information comprises at least one of a channel name, a program name and a televising time.

17. The display apparatus according to claim 16, wherein the controller controls the signal processor to display the broadcasting signal corresponding to the channel selected through the channel list in the sub picture.

18. The display apparatus according to claim 17, wherein the controller controls the signal processor to move the channel information displayed on the channel list in an up or down direction if a channel displayed on the channel list is selected using an up or down navigation function through the user selection unit, and to display the broadcasting signal of the channel selected by the up or down navigation function in the sub picture.

19. The display apparatus according to claim 17, wherein the controller controls the signal processor to move a highlight a channel displayed in the channel list in an up or down direction if the channel is selected using an up or down navigation function through the user selection unit, and to display the broadcasting signal corresponding to the highlighted channel in the sub picture.

20. The display apparatus according to claim 19, wherein the controller controls the signal processor to process the broadcasting signal of the channel displayed in the sub picture to be displayed as the main picture if the channel displayed in the sub picture is selected through the user selection unit.

21. The display apparatus according to claim 20, wherein the channel list is displayed on one of a right side or a left side in the main picture, and the sub picture is displayed in the middle of the channel list.

22. The display apparatus according to claim 21, wherein the controller controls the information related to the televising time, the channel name and the program name to be displayed translucently on the channel list.

23. The display apparatus according to claim 18, wherein the controller controls the signal processor to process the broadcasting signal of the channel displayed in the sub picture to be displayed as the main picture if the channel corresponding to the broadcasting signal displayed in the sub picture is selected.

24. The display apparatus according to claim 23, wherein the channel list is displayed on one of a right side or a left side in the main picture, and the sub picture is displayed in the middle of the channel list.

25. The display apparatus according to claim 24, wherein the controller controls the information related to the televising time, the channel name and the program name to be displayed translucently on the channel list.
